(19) United States
(12) Patent Application Publication
(10) Pub. No.: US 2015/0269753 A1
(43) Pub. Date: Sep. 24, 2015

(54) Multi-Output With Acquisition Replay System and Method

(71) Applicant: Siemens Medical Solutions USA, Inc., Malvern, PA (US)

(72) Inventor: Joseph John Devito, Crystal Lake, IL (US)

(21) Appl. No.: 14/661,561

(22) Filed: Mar. 18, 2015

Related U.S. Application Data
(60) Provisional application No. 61/954,639, filed on Mar. 18, 2014.

(51) Int. Cl. G06T 11/00; G06F 17/30

(52) U.S. Cl. CPC G06T 11/005; G06F 17/30247

(57) ABSTRACT

Generating multiple types of output data during a single nuclear acquisition. The output data can be used for advanced reconstruction.

### RELATED APPLICATION(S)

This application is a Non-Provisional Application, which claims benefit under 35 U.S.C. 119(e) of U.S. Provisional Application No. 61/954,639, filed Mar. 18, 2014, the content of which is hereby incorporated by reference in its entirety.

### FIELD

A system and method of nuclear data acquisition having multiple types of output data available for use in advanced reconstruction.

### BACKGROUND

Currently, during nuclear data acquisition only a single type of output data is generated and outputted. Thus, significant resources are required during the acquisition of legacy data sets for providing advanced reconstruction. Furthermore, the patient may need to be re-dosed one or more times to obtain sufficient nuclear data acquisitions for advance reconstruction.

### SUMMARY

An improved nuclear imaging data acquisition method.

An improved nuclear imaging data acquisition method for minimizing resources during the acquisition of a legacy data set.

An improved nuclear imaging data acquisition method for changing acquisition parameters and creating a new data set without re-dosing a patient.

A nuclear imaging data acquisition method comprising generating multiple types of output data during a single nuclear acquisition.

A nuclear imaging data acquisition method comprising generating multiple types of output data during a single nuclear acquisition, and conducting advanced reconstruction using the multiple types of output data.

A nuclear imaging data acquisition method comprising acquiring normal Legacy Data (2-dimensional projection data); saving gamma event data and control events into a list mode file; saving event gamma data; setting up new corrections required; sending list mode data in the list mode file back through a framing system, and replaying the list mode data to create a new data set (Raw Data) with different corrections applied to an exact same gamma event data set that created the Legacy Data (2-dimensional projection data).

A nuclear imaging method comprising acquiring on a nonvolatile memory 2-dimensional projection data for a gamma event in nuclear medicine; saving gamma event data and control events data into a list mode file; once the acquisition has met its stop condition, setting up new corrections required; sending the list mode data back through a framing system; replaying the list mode data to create one or more new data sets with different corrections applied to an exact same gamma event data set that created the 2-dimensional projection data; once framing has completed, sending all data to an acquisition console for advanced reconstruction; and selecting any of the one or more new data sets during advanced reconstruction to minimize resources during acquisition of the 2-dimensional projection data.

A nuclear imaging method comprising acquiring on a nonvolatile memory 2-dimensional projection data for a gamma event in nuclear medicine; saving gamma event data and control events data into a list mode file; once the acquisition has met its stop condition, setting up new corrections required; sending the list mode data back through a framing system; replaying the list mode data to create one or more new data sets with different corrections applied to an exact same gamma event data set that created the 2-dimensional projection data; once framing has completed, sending all data to an acquisition console for advanced reconstruction; selecting any of the one or more new data sets during advanced reconstruction to minimize resources during acquisition of the 2-dimensional projection data; and storing the 2-dimensional projection data on the nonvolatile memory during an image acquisition session.

A nuclear imaging method comprising acquiring on a nonvolatile memory 2-dimensional projection data for a gamma event in nuclear medicine; saving gamma event data and control events data into a list mode file; once the acquisition has met its stop condition, setting up new corrections required; sending the list mode data back through a framing system; replaying the list mode data to create one or more new data sets with different corrections applied to an exact same gamma event data set that created the 2-dimensional projection data; once framing has completed, sending all data to an acquisition console for advanced reconstruction; selecting any of the one or more new data sets during advanced reconstruction to minimize resources during acquisition of the 2-dimensional projection data; and storing the one or more new data sets on the nonvolatile memory.

A nuclear imaging method comprising acquiring on a nonvolatile memory 2-dimensional projection data for a gamma event in nuclear medicine; saving gamma event data and control events data into a list mode file; once the acquisition has met its stop condition, setting up new corrections required; sending the list mode data back through a framing system; replaying the list mode data to create one or more new data sets with different corrections applied to an exact same gamma event data set that created the 2-dimensional projection data; once framing has completed, sending all data to an acquisition console for advanced reconstruction; and selecting any of the one or more new data sets during advanced reconstruction to minimize resources during acquisition of the 2-dimensional projection data, wherein during the acquisition step, the gamma event data and the control events are acquired simultaneously.

A nuclear imaging method comprising acquiring on a nonvolatile memory 2-dimensional projection data for a gamma event in nuclear medicine; saving gamma event data and control events data into a list mode file; once the acquisition has met its stop condition, setting up new corrections required; sending the list mode data back through a framing system; replaying the list mode data to create one or more new data sets with different corrections applied to an exact same gamma event data set that created the 2-dimensional projection data; once framing has completed, sending all data to an acquisition console for advanced reconstruction; and selecting any of the one or more new data sets during advanced reconstruction to minimize resources during acquisition of the 2-dimensional projection data, wherein once the acquisition step has met a stop condition, the new corrections are setup.

A nuclear imaging method comprising acquiring on a nonvolatile memory 2-dimensional projection data for a gamma event in nuclear medicine; saving gamma event data and control events data into a list mode file; once the acquisition has met its stop condition, setting up new corrections required; sending the list mode data back through a framing system; replaying the list mode data to create one or more new data sets with different corrections applied to an exact same gamma event data set that created the 2-dimensional projection data; once framing has completed, sending all data to an acquisition console for advanced reconstruction; and selecting any of the one or more new data sets during advanced reconstruction to minimize resources during acquisition of the 2-dimensional projection data, wherein a nuclear imaging system for conducting the gamma event and a signal processing system are combined into a same system for conducting the method.

An improved nuclear imaging data acquisition system.

An improved nuclear imaging data acquisition system for minimizing resources during the acquisition of a legacy data set.

An improved nuclear imaging data acquisition system for changing acquisition parameters and creating a new data ste without re-dosing a patient.

A nuclear imaging system for enabling acquisition of 2-dimensional projection data from a nuclear imaging system and subsequent acquisition replay, comprising an acquisition apparatus for acquiring the 2-dimensional projection data associated with the nuclear imaging system during an image acquisition session and saving gamma event data and control events into a list mode data file; and replaying apparatus for replaying the list mode data in the list mode data file to create one or more new data sets with different corrections applied to an exact same gamma event data set that created the 2-dimensional projection data; and an acquisition console for advanced reconstruction of the one or more new data sets to minimize resources during acquisition of the 2-dimensional projection data.

A nuclear imaging system for enabling acquisition of 2-dimensional projection data from a nuclear imaging system and subsequent acquisition replay, comprising an acquisition apparatus for acquiring the 2-dimensional projection data associated with the nuclear imaging system during an image acquisition session and saving gamma event data and control events into a list mode data file; and replaying apparatus for replaying the list mode data in the list mode data file to create one or more new data sets with different corrections applied to an exact same gamma event data set that created the 2-dimensional projection data; an acquisition console for advanced reconstruction of the one or more new data sets to minimize resources during acquisition of the 2-dimensional projection data; and a nonvolatile memory means for storing the 2-dimensional projection data.

A nuclear imaging system for enabling acquisition of 2-dimensional projection data from a nuclear imaging system and subsequent acquisition replay, comprising an acquisition apparatus for acquiring the 2-dimensional projection data associated with the nuclear imaging system during an image acquisition session and saving gamma event data and control events into a list mode data file; and replaying apparatus for replaying the list mode data in the list mode data file to create one or more new data sets with different corrections applied to an exact same gamma event data set that created the 2-dimensional projection data; an acquisition console for advanced reconstruction of the one or more new data sets to minimize resources during acquisition of the 2-dimensional projection data; a nonvolatile memory means for storing the 2-dimensional projection data; and a nuclear imaging system having a signal processing stream.

A nuclear imaging system for enabling acquisition of 2-dimensional projection data from a nuclear imaging system and subsequent acquisition replay, comprising an acquisition apparatus for acquiring the 2-dimensional projection data associated with the nuclear imaging system during an image acquisition session and saving gamma event data and control events into a list mode data file; and replaying apparatus for replaying the list mode data in the list mode data file to create one or more new data sets with different corrections applied to an exact same gamma event data set that created the 2-dimensional projection data; an acquisition console for advanced reconstruction of the one or more new data sets to minimize resources during acquisition of the 2-dimensional projection data; a nonvolatile memory means for storing the 2-dimensional projection data; and an interface having an input and an output, said input being connected to said signal processing stream to receive the 2-dimensional data.

A nuclear imaging system for enabling acquisition of 2-dimensional projection data from a nuclear imaging system and subsequent acquisition replay, comprising an acquisition apparatus for acquiring the 2-dimensional projection data associated with the nuclear imaging system during an image acquisition session and saving gamma event data and control events into a list mode data file; and replaying apparatus for replaying the list mode data in the list mode data file to create one or more new data sets with different corrections applied to an exact same gamma event data set that created the 2-dimensional projection data; an acquisition console for advanced reconstruction of the one or more new data sets to minimize resources during acquisition of the 2-dimensional projection data; a nonvolatile memory means for storing the 2-dimensional projection data; and an interface having an input and an output, the input being connected to the signal processing stream to receive the 2-dimensional data.

A nuclear imaging system for enabling acquisition of 2-dimensional projection data from a nuclear imaging system and subsequent acquisition replay, comprising an acquisition apparatus for acquiring the 2-dimensional projection data associated with the nuclear imaging system during an image acquisition session and saving gamma event data and control events into a list mode data file; and replaying apparatus for replaying the list mode data in the list mode data file to create one or more new data sets with different corrections applied to an exact same gamma event data set that created the 2-dimensional projection data; an acquisition console for advanced reconstruction of the one or more new data sets to minimize resources during acquisition of the 2-dimensional projection data; a nonvolatile memory means for storing the 2-dimensional projection data; an interface having an input and an output, the input being connected to the signal processing stream to receive the 2-dimensional data; and a controller in electrical communication with the interface and the nonvolatile memory.

A nuclear imaging system for enabling acquisition of 2-dimensional projection data from a nuclear imaging system and subsequent acquisition replay, comprising an acquisition apparatus for acquiring the 2-dimensional projection data associated with the nuclear imaging system during an image acquisition session and saving gamma event data and control events into a list mode data file; and replaying apparatus for replaying the list mode data in the list mode data file to create one or more new data sets with different corrections applied to an exact same gamma event data set that created the 2-dimensional projection data; an acquisition console for advanced reconstruction of the one or more new data sets to minimize resources during acquisition of the 2-dimensional projection data; a nonvolatile memory means for storing the 2-dimensional projection data; an interface having an input and an output, the input being connected to the signal processing stream to receive the 2-dimensional data; and a controller in electrical communication with the interface and the nonvolatile memory, wherein the interface comprises a buffer connecting the input to the nonvolatile memory, the buffer designed to buffer and translate the 2-dimensional data from one format to another.

A nuclear imaging system for enabling acquisition of 2-dimensional projection data from a nuclear imaging system and subsequent acquisition replay, comprising an acquisition apparatus for acquiring the 2-dimensional projection data associated with the nuclear imaging system during an image acquisition session and saving gamma event data and control events into a list mode data file; and replaying apparatus for replaying the list mode data in the list mode data file to create one or more new data sets with different corrections applied to an exact same gamma event data set that created the 2-dimensional projection data; an acquisition console for advanced reconstruction of the one or more new data sets to minimize resources during acquisition of the 2-dimensional projection data; a nonvolatile memory means for storing the 2-dimensional projection data; an interface having an input and an output, the input being connected to the signal processing stream to receive the 2-dimensional data; and a controller in electrical communication with the interface and the nonvolatile memory, wherein the interface comprises a buffer connecting the input to the nonvolatile memory, the buffer designed to buffer and translate the 2-dimensional data from one format to another, and wherein the controller is a processor programmed by a control software program.

### BRIEF DESCRIPTION

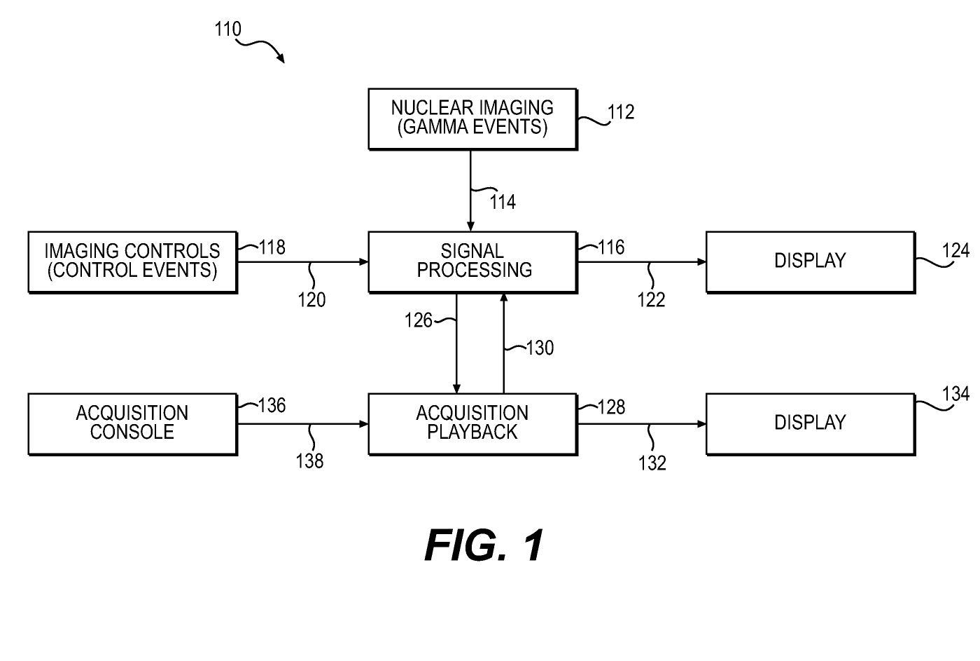

FIG. 1 is a block diagram of an embodiment of a nuclear imaging system.

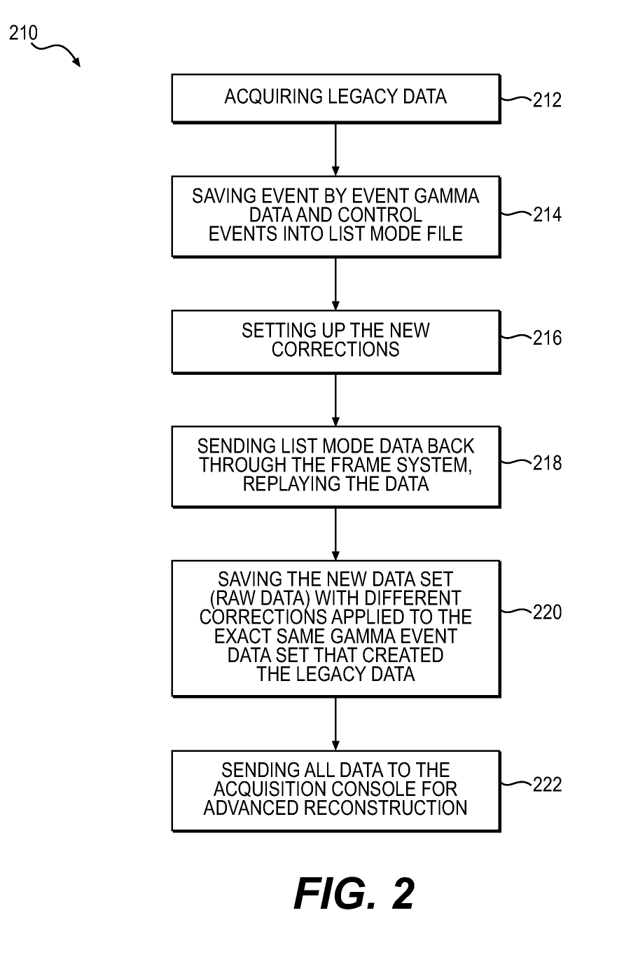

FIG. 2 is a basic flow diagram of an embodiment of a nuclear imaging method.

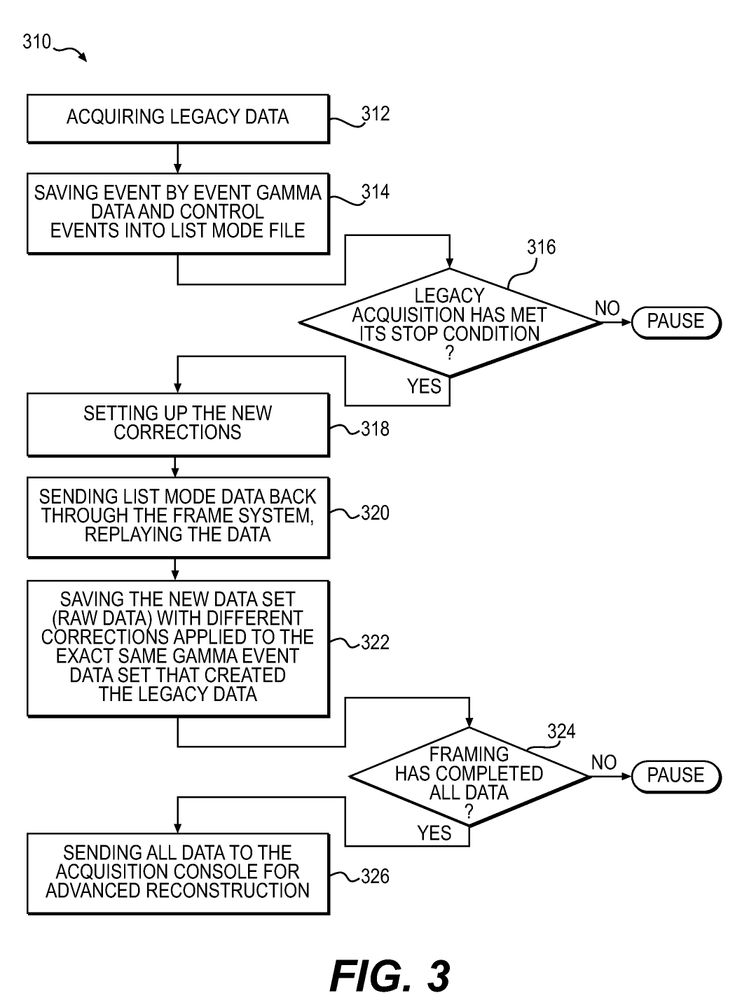

FIG. 3 is more advanced flow diagram of an embodiment of a nuclear imaging method.

### DETAILED DESCRIPTION

### Multi-Output with Acquisition Replay

In accordance with an embodiment of the invention during a single nuclear acquisition, it is desired to have multiple types of output data available for advanced reconstruction, e.g., Legacy data which is 2 dimensional framed data with corrections applied, Raw data which is 2 dimensional framed data with any combination of corrections applied but not the same as the Legacy data, and List mode Data which is all gamma events and controls events in an event by event stream of data.

The Legacy Data is used for user display and legacy reconstruction algorithms. The Raw data needed for advanced reconstruction and list mode data is used for research and development.

While acquiring normal Legacy Data (2 dimensional projection data) for nuclear medicine, the event is saved by event gamma data and control events into a list mode file. Once the legacy acquisition has met its stop condition setup the new corrections are acquired, the list mode data is sent back through the framing system, and the data is replayed. This will create a new data set (Raw Data) with different corrections applied to the exact same gamma event data set that created the Legacy Data. Once the framing has completed all the data can be sent to the acquisition console for advance reconstruction. Advanced reconstruction can then choose to use any of the data from any of the data sets because the gamma events used to create each data set are the same. The reason for replaying the data is to minimize resources during the acquisition of the legacy data set.

### Nuclear Imaging System

A nuclear imaging system 110 is shown in FIG. 1. The nuclear imaging system 110 includes a nuclear imaging device 112 for generating a nuclear imaging signal 114, which can be sent to the signal processing device 116.

The nuclear imaging system 110 further includes an imaging control device 118 for generating an imaging control signal 120, which can be sent to the signal processing device 116. The signal processing device 116 can generate a display signal 120, which can be sent to the display 124.

The signal processing device 116 can also generate a signal processing signal 126, which can be sent to an acquisition/playback device 128. The acquisition/playback device 128 can generate an acquisition/playback signal 130, which can be sent to the signal processing device 116. Thus, the signal processing device 116 and acquisition/playback communicate back and forth with each other.

The acquisition/playback device 128 can generate a display signal 132, which can be sent to the display 134. The display 124 and display 134 can be separate displays or a signal consolidated display. The acquisition/playback device 128 can include computer memory for storing the Legacy data, Raw data, and List mode data. Alternatively, or in addition, another data storage device can be added to the nuclear imaging system 110 (e.g. connected to acquisition/playback device 128), or can be remotely located.

The nuclear imaging system 110 further includes an acquisition console device 136. The acquisition/playback device 128 can be configured to send the multiple types of output data signal 138 to the acquisition console device 136.

In operation, during a single nuclear acquisition, multiple types of output data can be generated and stored for use in advanced reconstruction. The event by event gamma data and control events are saved into the list mode file. Then, the list mode data can be sent back through the framing system, replaying the data. This creates the new data set (Raw Data) with different corrections applied to the exact same gamma event data set that created the Legacy Data. Once the framing has completed all of the data can be sent to the acquisition console for advanced reconstruction. Advanced reconstruction can then choose to use any of the data from any of the saved data sets because the gamma events used to create each data set are the same. Again, replaying he data minimizes the resources during the acquisition of the legacy data set.

### Nuclear Imaging Method

The basic nuclear imaging method 210 is shown in FIG. 2. The nuclear imaging method includes acquiring legacy data (step 212), saving event by event gamma data and control events into list mode file (step 214), setting up the new corrections (step 216), sending list mode data back through the frame system, replaying the data (step 218), saving the new data set (raw data) with different corrections applied to the exact same gamma event data set that created the legacy data (step 220), and sending all data to the acquisition console for advanced reconstruction (step 222).

A more advanced nuclear imaging method 310 is shown in FIG. 3. The nuclear imaging method includes acquiring legacy data (step 312), saving event by event gamma data and control events into list mode file (step 314), legacy acquisition has met its stop condition (decision 316), setting up the new corrections (step 318), sending list mode data back through the frame system, replaying the data (step 320), saving the new data set (raw data) with different corrections applied to the exact same gamma event data set that created the legacy data (step 322), framing has completed all data (decision 324), and sending all data to the acquisition console for advanced reconstruction (step 326).

I claim:

1. A method, comprising:
acquiring on a nonvolatile memory 2-dimensional projection data for a gamma event in nuclear medicine;
saving gamma event data and control events data into a list mode file;
setting up new corrections;
sending the list mode data back through a framing system;
replaying the list mode data to create one or more new data sets with different corrections applied to an exact same gamma event data set that created the 2-dimensional projection data;
once framing has completed, sending all data to an acquisition console for advanced reconstruction; and
selecting any of the one or more new data sets during advanced reconstruction to minimize resources during acquisition of the 2-dimensional projection data.

2. The method according to claim 1, further comprising the step of storing the 2-dimensional projection data on the nonvolatile memory during an image acquisition session.

3. The method according to claim 1, further comprising the step of storing the one or more new data sets on the nonvolatile memory.

4. The method according to claim 1, wherein during the acquisition step, the gamma event data and the control events are acquired simultaneously.

5. The method according to claim 1, wherein once the acquisition step has met a stop condition, the new corrections are setup.

6. The method of claim 1, wherein a nuclear imaging system for acquiring the 2-dimensional projection data and a signal processing system are portions of a same system.

7. A nuclear imaging system, comprising:
an acquisition device for acquiring the 2-dimensional projection data associated with the nuclear imaging system during an image acquisition session;
a replaying device for replaying the list mode data to create one or more new data sets with different corrections applied to an exact same gamma event data set that created the 2-dimensional projection data; and
an acquisition console device for advanced reconstruction of the one or more new data sets to minimize resources during acquisition of the 2-dimensional projection data.

8. The system according to claim 7, further comprising a nonvolatile memory device for storing the 2-dimensional projection data.

9. The system according to claim 8, including a nuclear imaging system having a data stream.

10. The system according to claim 9, including an interface having an input and an output, said input being connected to said signal processing pipeline to receive the 2-dimensional data.

11. The system according to claim 10, including a controller in electrical communication with the interface and the nonvolatile memory device.

12. The system according to claim 11, wherein said interface comprises:
a buffer connecting the input to the nonvolatile memory device, the buffer designed to buffer and translate the 2-dimensional data from one format to another.

13. The system according to claim 12, wherein said controller is a processor programmed by a control software program.

14. The system according to claim 7, further comprising a nuclear imaging device.
